(19) United States
(12) Patent Application Publication
(10) Pub. No.: US 2026/0225326 A1
(43) Pub. Date: Aug. 6, 2026

(54) CONTINUOUS FIBER REINFORCEMENT IN A PULTRUSION PROCESS

(71) Applicant: Pulflex Technologies LLC, Ford City, PA (US)

(72) Inventor: Steven Mansfield, New Brighton, PA (US)

(73) Assignee: Pulflex Technologies LLC, Ford City, PA (US)

(21) Appl. No.: 19/531,646

(22) Filed: Feb. 5, 2026

Related U.S. Application Data
(60) Provisional application No. 63/754,308, filed on Feb. 5, 2025.

(51) Int. Cl. B29C 70/24; B29C 70/52

(52) U.S. Cl. CPC B29C 70/24; B29C 70/52

(57) ABSTRACT

A matrix of materials includes a plurality of continuous reinforcing fibers woven together into a tubular form and pultruded in a first direction to form a matrix of materials. The continuous reinforcing fibers are positioned at an off-axis angle relative to the first direction. The tubular form that results is seamless.

### CROSS-REFERENCE TO RELATED APPLICATION

This application claims priority to U.S. Provisional Ser. No. 63/754,308 , filed on Feb. 5, 2025, the disclosure of which is incorporated herein by reference in its entirety.

### FIELD

The present invention concerns the use of continuous fiber reinforcement in a pultrusion process that utilizes continuous reinforcing fibers in an off-axis direction of the pulling process.

### BACKGROUND

Typical reinforced fiber structures are made in flat sheets 10 and then formed into a finished geometry, as shown in FIGS. 1-3.

FIG. 4 depicts a tube 12 made using reinforced fiber sheets 10 using an overlap joint 14. While two joints 14 are shown in FIG. 4, a single joint may alternatively be used on one side of the tube 12. The overall strength of the resulting tube 12 is dependent on the shear strength of the resin at the overlap joint 14 because the fiber, which provides the high tensile strength and mechanical properties for the tube 12, is not continuous. This is typically how pultrusion is performed. There may be multiple joints and overlapping sections, which affect overall properties, such as strength. The two pieces will overlap and bond using a resin and heat to produce a finished part.

### SUMMARY

A matrix of materials includes a plurality of continuous reinforcing fibers woven together into a tubular form and pultruded in a first direction to form a matrix of materials. The continuous reinforcing fibers are positioned at an off-axis angle relative to the first direction. A pultrusion process includes pulling the material in a first direction using a continuous fiber reinforcement to form a matrix of material. The continuous fiber reinforcement is placed in an off-axis angle relative to the first direction to produce a tubular member that is seamless.

### BRIEF DESCRIPTION OF THE DRAWINGS

FIG. 1 depicts a prior art woven fiber sheet where some of the fibers are oriented off-angle relative to the longitudinal direction of the sheet;

FIG. 2 depicts a prior art woven fiber sheet where the fibers are oriented in a direction that is parallel and perpendicular to the longitudinal direction of the sheet;

FIG. 3 depicts a prior art woven fiber material on a roll;

FIG. 4 depicts a prior art tubular member formed from two fiber sheets having overlapping sections on either side of the tube;

FIG. 5 depicts a prior art process utilized in forming the tubular member shown in FIG. 4;

FIG. 6 depicts a pre-formed tubular woven fiber material where the fibers are continuous for feeding into a pultrusion process;

FIG. 7 depicts a tubular member similar to that in FIG. 5 where the material has been bathed in resin and formed into a marquise shape;

FIG. 8 depicts an alternative pre-formed tubular woven fiber material where the fibers are continuous for feeding into a pultrusion process; and

FIG. 9 depicts a pre-formed tubular woven fiber material prior to treatment with a pultrusion process on the left side and a finished tubular member after treatment with a pultrusion process.

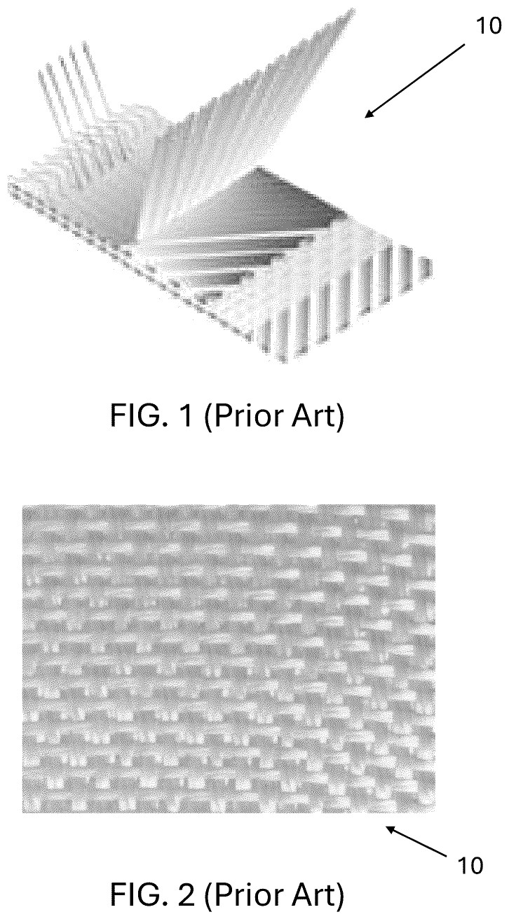

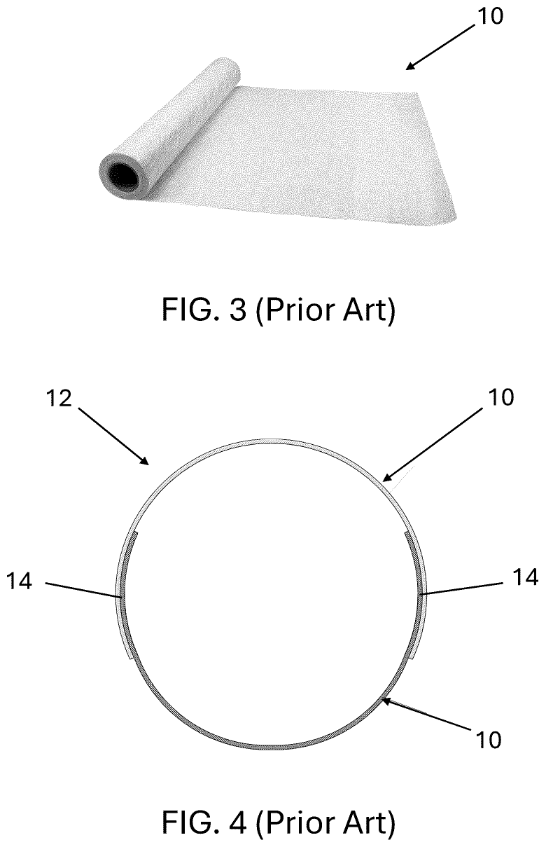

### DETAILED DESCRIPTION

There are many types of reinforcement fibers made today, with an almost infinite number of off-axis fibers placed in the fiber matrix at the customer's request. The invention described herein involves the use of a continuous fiber reinforcement in a pultrusion process. The continuous fiber reinforcement is used in an off-axis to the direction of the pultrusion pulling process. The use of continuous fibers in an off-axis direction to the pulling direction in a pultrusion provides a very high strength, non-overlapping product that can be manufactured in a continuous manufacturing process. The continuous reinforcing fiber or fibers are used in the pultrusion process to produce a continuous structure of reinforcing fiber or fibers in a multitude of axial configurations in a single fiber structure.

Off-axis fibers are angled relative to a pull direction and/or longitudinal direction of movement of the material through a die. The off-axis fibers may be angled at an angle ranging relative to the pull direction from 1 degree to 89 degrees. In another example, the off-axis fibers may be angled at an angle of 10 degrees to 80 degrees. In yet another example, the off-axis fibers may be angled at an angle of 20 degrees to 70 degrees. In yet another example, the off-axis fibers are angled at an angle of 30 degrees to 60 degrees. In another example, the fibers are angled at 10 degrees, 15 degrees, 20 degrees, 25 degrees, 30 degrees, 35 degrees, 40 degrees, 45 degrees, 50 degrees, 55 degrees, 60 degrees, 65 degrees, or 70 degrees, among other angles, relative to the pull direction X-X.

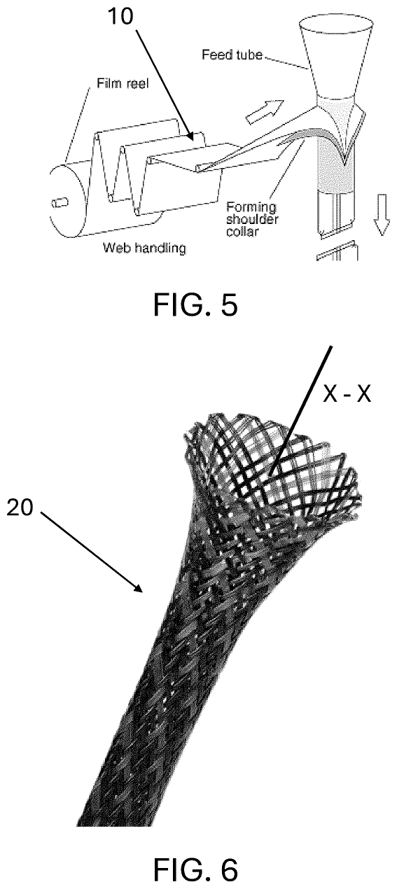

As shown best in FIGS. 4 and 5, current processes for forming tubular members 12 of reinforced fibers utilize as sheets of material 10 that are formed into a cylinder and the ends of the sheets of material 10 are bonded together to form the cylindrical shape 12. This results in points of failure that may occur at the overlap joints 14. The present invention is directed toward remedying any issues with the prior art by eliminating the potential for failure at the joints 14. The tubular member 12 shown in FIG. 4 has two joints 14, one on either side of the tubular member 12.

In the present invention, a pultrusion process is utilized along with a woven, tubular material 20 (shown in FIG. 6) that is made up of continuous fibers that are woven so that the direction of the fibers is off-axis relative to the pulling axis X-X of the pultrusion process. The tubular material 20 is embedded with a resin and then pulled through a pultrusion die to create a tubular member 30 having no seams. Because no seams are present, the finished product has superior strength to prior art tubular members, described above.

The objective of the present invention is to utilize a continuous fiber in the pultrusion process to create a very high strength, non-overlapping tubular member 30 that can be produced in a continuous manufacturing process. FIGS. 6-9 depict an example of a pultrusion overlap of fibers in a tubular shape utilized in connection with the current invention.

Examples of several different pultrusion processes are described in applicant's pending patent applications including U.S. patent application Ser. No. 18/948,433, filed on Nov. 14, 2024, and U.S. patent application Ser. No. 17/835,904, filed on Jun. 8, 2022, the disclosures of which are incorporated herein by reference in their entirety.

Pultrusion is a continuous, automated manufacturing process used to produce high-strength, fiber-reinforced polymer profiles. It involves pulling reinforcing fibers through a resin bath for saturation and then through a heated die, which shapes and cures the material into a rigid profile. Different shapes may be formed including sheets, tubes, or shapes having a varying profile, such as supports, among other shapes.

Pultrusion allows for the production of any length of product. The process results in well-aligned fibers, which leads to a compact, high fiber content and strong product. Pultrusion can be more cost-effective compared to other composite manufacturing methods, like filament winding or prepreg hand lay-up. Pultrusion is highly automatable, which allows for high production rates and uniform quality in the finished products. Pultruded products also exhibit high strength-to-weight ratios, corrosion resistance, good electrical insulation, and dimensional stability. Pultrusion is primarily suited for producing straight, constant cross-section profiles. The dimensional tolerances of pultruded parts may not be as precise as those achieved by other manufacturing methods. Producing thin-walled components can be difficult with pultrusion.

A typical pultrusion process involves utilizing continuous fiber reinforcements, such as rovings, e.g., spools of fiber, and mats, which are pulled from the spool. The fibers then pass through a resin bath where they are thoroughly saturated with a resin. They may also be saturated with fillers and additives. The saturated resin fibers are then organized and shaped by a preform, which squeezes out excess resin before the material enters a die. A die is used to shape the material. The material is pulled through or around a heated steel die. Heat initiates a polymerization reaction (curing) to solidify the resin. A continuous pulling system draws the material through the die. Once the material is free from the die, an automated saw cuts the solidified, continuous profile to a desired length.

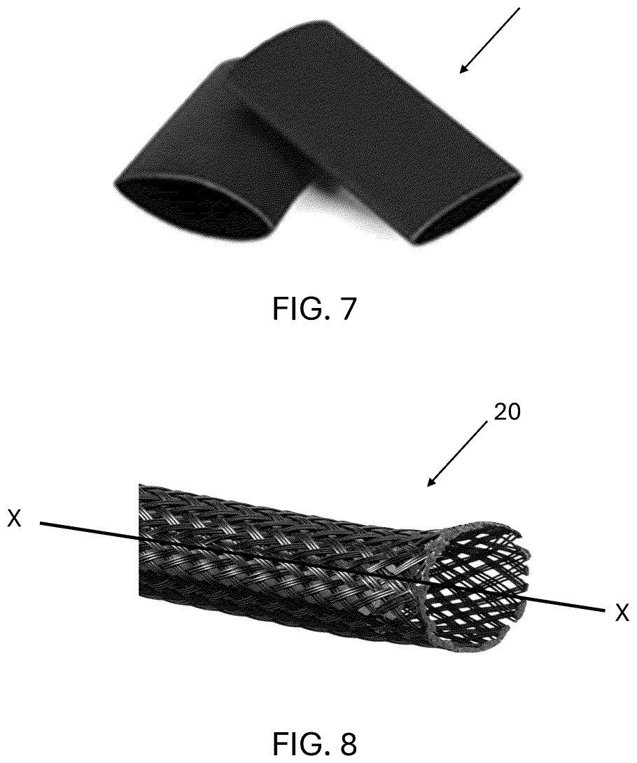

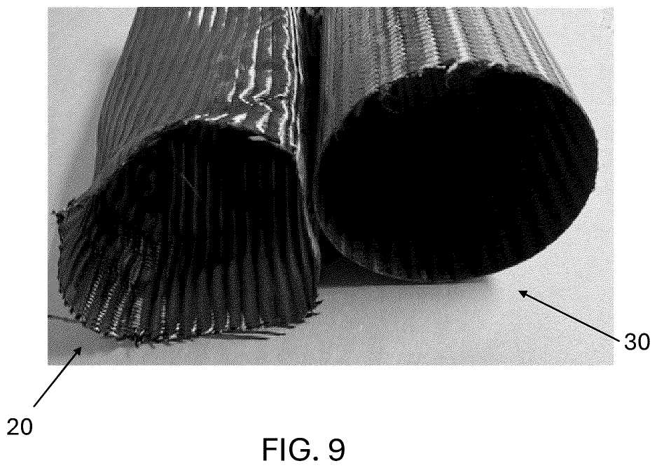

As shown in FIG. 9, the shape of the tubular member 30 may be of a constant cylindrical shape or, alternatively, the shape can be fluted or otherwise shaped, based upon the shape of the die. Other shapes may also be created, including rectangular shapes, oval shapes, marquise shapes, and many other shapes where the shape is tubular in nature. An example of a marquise shape is shown in FIG. 7.

According to the invention, a matrix of materials includes a plurality of continuous reinforcing fibers woven together into a tubular form and pultruded in a first direction to form a matrix of materials. The continuous reinforcing fibers are positioned at an off-axis angle relative to the first direction within the tubular form such that the matrix of materials is seamless.

The matrix of materials may have a cross-sectional shape defined by discreet sides separated by one or more vertices. The cross-sectional shape may be cylindrical, oval, square, triangular, marquise, or rectangular. The off-axis angle may be about 45 degrees. The off-axis angle may range from about 10 degrees to about 80 degrees, about 20 degrees to about 70 degrees, about 30 degrees to about 60 degrees, or about 40 degrees to about 50 degrees.

The fibers may be positioned at an off-axis angle of about 20 degrees, about 30 degrees, about 40 degrees, about 50 degrees, about 60 degrees, about 70 degrees, or about 80 degrees. The plurality of continuous reinforcing fibers may include both off-axis fibers that are angled relative to the first direction and aligned fibers that are aligned with the first direction.

In another embodiment, a pultrusion process that includes pulling of material in a first direction includes using a continuous fiber reinforcement in the pulling of material during the pultrusion process to form a matrix of material. The continuous fiber reinforcement is placed at an off-axis angle relative to the first direction to produce a tubular member that is seamless.

The continuous fiber reinforcement may include a plurality of continuous reinforcing fibers woven together into a tubular form and pultruded in the first direction to form the matrix of materials. The continuous reinforcing fibers may be positioned at an off-axis angle ranging from about 10 degrees to about 80 degrees, about 20 degrees to about 70 degrees, about 30 degrees to about 60 degrees, or about 40 degrees to about 50 degrees relative to the first direction. The continuous reinforcing fibers may be positioned at an off-axis angle of about 20 degrees, about 30 degrees, about 40 degrees, about 45 degrees, about 50 degrees, about 60 degrees, about 70 degrees, or about 80 degrees.

The tubular member may have one or more sides. The tubular member may have one or more vertices. The tubular member may have two or more sides and the sides are separated by vertices. The tubular member is rectangular, triangular, or marquise. The pultrusion process is round, oval or heart shaped. The plurality of continuous reinforcing fibers may include both off-axis fibers that are angled relative to the first direction and aligned fibers that are aligned with the first direction.

The term “substantially,” if used herein, is a term of estimation.

While various features are presented above, it should be understood that the features may be used singly or in any combination thereof. Further, it should be understood that variations and modifications may occur to those skilled in the art to which the claimed examples pertain. The examples described herein are exemplary. The disclosure may enable those skilled in the art to make and use alternative designs having alternative elements that likewise correspond to the elements recited in the claims. The intended scope may thus include other examples that do not differ or that insubstantially differ from the literal language of the claims. The scope of the disclosure is accordingly defined as set forth in the appended claims.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim. The term “consisting essentially,” if used herein, means the specified materials or steps and those that do not materially affect the basic and novel characteristics of the material or method. All percentages and averages are by weight unless the context indicates otherwise. If not specified above, the properties mentioned herein may be determined by applicable ASTM standards, or if an ASTM standard does not exist for the property, the most commonly used standard known by those of skill in the art may be used. The articles “a,” “an,” and “the,” should be interpreted to mean “one or more” unless the context indicates the contrary.

What is claimed is:

1. A matrix of materials comprising:
a plurality of continuous reinforcing fibers woven together into a tubular form and pultruded in a first direction to form a matrix of materials, wherein the continuous reinforcing fibers are positioned at an off-axis angle relative to the first direction within the tubular form such that the matrix of materials is seamless.

2. The matrix of materials according to claim 1, wherein the matrix of materials has a cross-sectional shape defined by discreet sides separated by one or more vertices.

3. The matrix of materials according to claim 2, wherein the cross-sectional shape is cylindrical, oval, square, triangular, marquise, or rectangular.

4. The matrix of materials according to claim 1, wherein the off-axis angle is about 45 degrees.

5. The matrix of materials according to claim 1, wherein the off-axis angle ranges from about 10 degrees to about 80 degrees, about 20 degrees to about 70 degrees, about 30 degrees to about 60 degrees, or about 40 degrees to about 50 degrees.

6. The matrix of materials according to claim 1, wherein the fibers are positioned at an off-axis angle of about 20 degrees, about 30 degrees, about 40 degrees, about 50 degrees, about 60 degrees, about 70 degrees, or about 80 degrees.

7. The matrix of materials according to claim 1, wherein the plurality of continuous reinforcing fibers includes both off-axis fibers that are angled relative to the first direction and aligned fibers that are aligned with the first direction.

8. A pultrusion process that includes pulling of material in a first direction comprising:
using a continuous fiber reinforcement in the pulling of material during the pultrusion process to form a matrix of material, with the continuous fiber reinforcement being placed in an off-axis angle relative to the first direction to produce a tubular member that is seamless.

9. The pultrusion process of claim 8, wherein the continuous fiber reinforcement comprises a plurality of continuous reinforcing fibers woven together into a tubular form and pultruded in the first direction to form the matrix of materials.

10. The pultrusion process of claim 9, wherein the continuous reinforcing fibers are positioned at an off-axis angle ranging from about 10 degrees to about 80 degrees, about 20 degrees to about 70 degrees, about 30 degrees to about 60 degrees, or about 40 degrees to about 50 degrees relative to the first direction.

11. The pultrusion process of claim 9, wherein the continuous reinforcing fibers are positioned at an off-axis angle of about 20 degrees, about 30 degrees, about 40 degrees, about 45 degrees, about 50 degrees, about 60 degrees, about 70 degrees, or about 80 degrees.

12. The pultrusion process of claim 8, wherein the tubular member has one or more sides.

13. The pultrusion process of claim 12, wherein the tubular member has one or more vertices.

14. The pultrusion process of claim 12, wherein the tubular member has two or more sides and the sides are separated by vertices.

15. The pultrusion process of claim 14, wherein the tubular member is rectangular, triangular, or marquise.

16. The pultrusion process of claim 8, wherein the pultrusion process is round, oval or heart shaped.

17. The pultrusion process of claim 8, wherein the plurality of continuous reinforcing fibers includes both off-axis fibers that are angled relative to the first direction and aligned fibers that are aligned with the first direction.
